(19) United States
(12) Patent Application Publication
(10) Pub. No.: US 2024/0121863 A1
(43) Pub. Date: Apr. 11, 2024

(54) ELECTRIC HEATING DEVICE AND METHOD FOR PRODUCING AN ELECTRIC HEATING DEVICE

(71) Applicant: Türk & Hillinger GmbH, Tuttlingen (DE)

(72) Inventor: Andreas SCHLIPF, Tuttlingen (DE)

(21) Appl. No.: 18/276,220

(22) PCT Filed: Jan. 27, 2022
(86) PCT No.: PCT/EP2022/051888

§ 371 Date: Aug. 7, 2023

(30) Foreign Application Priority Data
Feb. 8, 2021 (DE) 10 2021 102 893.0

(51) Int. Cl. H05B 3/48

(52) U.S. Cl. CPC H05B 3/48

(57) ABSTRACT

An electrical heating device with an electrical heating element, which is arranged inside of a tube-shaped metal jacket and is electrically insulated from this jacket with a compacted, electrically insulating material. The electrical heating element has coils with a flat ribbon geometry. The coil has an inner diameter, an outer diameter, and a spacing between adjacent coils. The coils are shaped such that a flat side runs parallel to the coil axis. The compacted electrically insulating material is either a compacted granulate made from granulate grains of different sizes with edges and protrusions or components of a molded part produced during the compaction of the molded part. A surface of the coil has sections in which granulate grains or components of the molded part produced during the compaction of the molded part, under local deformation of the electrical heating element, are pressed at least partially into the electrical heating element.

### CROSS-REFERENCE TO RELATED APPLICATIONS

This application is a Section 371 of International Application No. PCT/EP2022/051888, filed Jan. 27, 2022, which was published in the German language on Aug. 11, 2022 under International Publication No. WO 2022/167316 A1, which claims priority under 35 U.S.C. § 119(b) to German Patent Application No. 10 2021 102 893.0, filed on Feb. 8, 2021, the disclosures of which are incorporated herein by reference in their entirety.

### BACKGROUND OF THE INVENTION

There are a number of electrical heating devices with an electrical heating element, which is arranged inside the tube interior of a tube-shaped metal jacket and is electrically insulated from this jacket with an electrically insulating material.

In practical applications, it is a challenge in many use cases to dissipate the heat generated by the electrical heating element as effectively as possible, in particular, to the tube-shaped metal jacket.

The problem of the invention is therefore to provide an electrical heating device with an electrical heating element which is arranged inside the tube interior of a tube-shaped metal jacket and is electrically insulated from the jacket with an electrically insulating material, in which the heat dissipation from the electrical heating element is improved. The problem of the invention is also to specify a manufacturing method for such an electrical heating device.

### BRIEF SUMMARY OF THE INVENTION

This problem is solved by a device with the features of the electrical heating element described herein and a method with the features and steps described herein. Advantageous refinements are the subject matter of the dependent patent claims.

The electric heating device according to the preferred invention has an electric heating element, which is arranged, without a carrier, inside the interior of the tube of at least one tube-shaped metal jacket and is electrically insulated from the jacket with a compacted, electrically insulating material. Without a carrier means, in particular, that the electrical heating element is not coiled onto a winding body. In general, it will be a self-supporting structure that is brought into a predetermined shape and maintains this shape without the influence of external stabilization measures.

Firstly, it is preferred that the electrical heating element has coils with a flat ribbon geometry at least in sections. The coils with a flat ribbon geometry having an inside diameter, an outside diameter, and a spacing between adjacent coils and are shaped in such a way that the flat side of the coils with a flat ribbon geometry runs parallel to the coil axis. In the simplest case, it can be a self-supporting coiled resistance wire with a flat ribbon geometry; however, electrical heating elements with the appropriate geometry can also be machined from blanks, e.g., by laser cutting or water jet cutting. It can also be advisable to first make the cuts on a plate-shaped blank and then to deform the blank, in particular, to roll or coil it.

Even if the term does not actually need to be explained, it should nevertheless be mentioned here that flat ribbon geometry is to be understood as a property of the cross section of the coil, which is perpendicular to the running direction of the resistance material from which it is formed. This cross section is generally rectangular with a long dimension defining the width and a short dimension defining the height. However, the corners could be rounded and the profile of the sides, in particular, in the height direction, but also in the width direction, does not have to be exactly linear.

In fact, the coiling of a resistance wire with a flat ribbon geometry to form a corresponding electrical heating element can slightly change the preferred, essentially rectangular cross-sectional geometry, but the use of the term flat ribbon geometry is still appropriate here.

The flat side of the resistance wire is to be understood as the side which runs essentially parallel to the long direction of extent of its cross section.

The use of the coil with flat ribbon geometry in the orientation in which the flat side runs parallel to the coil axis means that even if the electrical heating device in which the electrical heating element is used can have only a small diameter, the electrical heating element can have a significant cross section, which is important in the case of high current loads. In contrast to elongated resistance wires with a relatively large cross section, which have often been used up to now, the coiled structure enables the electrical heating element to react more resiliently to alternating thermal loads, which results in significantly slower embrittlement and material fatigue and a lower risk of breakage.

In addition, there is a second very important aspect, namely the fact that, in the claimed configuration, a coiled resistance wire with a flat ribbon geometry automatically has larger surfaces as contact areas that enable heat dissipation, particularly in the direction of the tube-shaped metal jacket.

Tests by the applicant have shown that it is advantageous if the width of the coil with a flat ribbon geometry corresponds to at least 30% of the inner diameter of the coil. It has turned out to be particularly preferred if the width of the coil with the flat ribbon geometry corresponds to the outer diameter of the coil.

Tests have further shown that the width of the coil with a flat ribbon geometry is preferably at least twice as wide as its height, for some applications it can also reach ten times the height. Preferably, the height should be chosen sufficiently large to allow the coil of the electrical heating element to support its own weight, so that the electrical heating element, even if supported at only one end, will maintain its shape and will not change due to the effects of gravity at locations where it is not supported.

It was also determined through tests that the spacing between adjacent coils is preferably smaller than the width of the coils with a flat ribbon geometry. A spacing value of about 15% of the width is considered realistic. One goal is to realize small spacing values.

Secondly, it is preferred that the compacted electrically insulating material is a compacted granulate of grains of different sizes with edges and protrusions, at least in portions of the interior of the tube-shaped metal jacket that are adjacent to at least one coil. This arrangement then makes it possible for at least one surface of at least one coil to have sections in which grains of this granulate are at least partially pressed into the electrical heating element, with local deformation, in particular, of the electrical heating element. This increases the contact surface between the electrical heating element and the electrically insulating material, which enables better heat dissipation.

In addition, it has been shown that the same effect can also be achieved if the compacted insulating material is a compacted molded part made of an electrically insulating material, because then components, in particular fragments, of this molded part are at least partially pressed into the electrical heating element under local deformation, in particular, of the electrical heating element.

The use of magnesium oxide granulate is particularly advantageous, which is why this material is used in the description below.

This approach represents, to a certain extent, a paradigm shift. Until now, the choice of which electrically insulating material to use and the magnitude of the pressure to apply during compaction have always been largely determined by considering how to maximize the comparative tracking index and resistance to moisture, which is why powders with very fine and regular shaped powder particles have been used in order to obtain as homogeneous an insulating material layer as possible during compaction.

The use of a granulate according to the invention differs fundamentally from the prior approach. Unlike a powder, a granulate within the meaning of this disclosure has coarse, irregular grains with edges and protrusions, i.e., less roundness, with these grains also having a relatively wide particle size distribution with a Full Width Half Maximum (“FWHM”) value for the width of the distribution, which is between a few tens of μm and over a hundred μm, particularly in the case of magnesium oxide granulate. The maximum of the magnesium oxide grain size distribution of the magnesium oxide granulate being used can preferably be in the range between about 30 μm and about 300 from which it can be seen that the particle size alone is not the decisive parameter.

An indirect, macroscopically determinable measure of these properties of the granulate is the tap or tapped density. For example, magnesium oxide granulate within the meaning of this invention have a tapped density of less than 2.45 g/cm3 before compaction, while the density of magnesium oxide is given as 3.58 g/cm3. When the tube-shaped metal jacket is filled, an electrical insulation layer is initially formed which has a considerable proportion of empty volumes.

While intuitively it would be assumed that sufficient comparative tracking index and moisture resistance cannot be achieved due to the voids that remain within the area filled with electrically insulating material and the voids would counteract these properties, the inventor has found, surprisingly, that by applying high pressure such that sections of particles adjacent to coils of the electrical heating element and/or to the tube-shaped metal jacket, in particular, edges and protrusions of grains, are pressed into the electrical heating element and/or into the tube-shaped metal jacket, under local deformation of the electrical heating element and/or the tube-shaped metal jacket, an electrical insulation layer with high comparative tracking index and moisture resistance can be realized, which also proves mechanically to be significantly more stable than known electrical insulation layers in such devices.

A further advantage resulting from the use of a granulate according to the invention is that it achieves improved tolerance compensation.

However, the most preferred aspect for the solution of the problem according to the preferred invention is that a significant improvement in the heat conduction of the electrical insulation layer has also been observed. This can be realized, on one hand, by a lower proportion of grain boundaries due to a higher proportion of larger granulate. On the other hand, this is also realized because pressing the granulate into the coil of the electrical heating element also promotes heat dissipation, since the transfer area is effectively larger. These effects are maximized by the flat ribbon geometry of the coil of the heating element, which is coiled at least in sections.

The effects described above for the granulate occur in a similar manner when the electrically insulating material is a compacted article of electrically insulating material. The irregular components or fragments of this molded part, which are produced when the molded part is compacted, then take the place of the granulate.

In this way, an (additional) roughness is imparted to the electrical heating element or its coil, but also to the tube-shaped metal jacket during compaction by the granulate or the components of the compacted molded part produced during compaction. Tests have shown that for typical inner conductor materials, for example, mean roughness values Ra of a few μm and mean smoothing depths Rp of around ten micrometers (10 μm) can be achieved.

The pressure required for compaction can be provided, for example, by press compaction, roller compaction, or hammer compaction. Particularly preferred are pressures that are so high that the inner conductor is plastically deformed, in particular, such that the diameter of the inner conductor is reduced by a few percent, preferably about five percent (5%).

If necessary, the moisture resistance in particular, can be further increased by impregnating the compacted granulate, in particular magnesium oxide granulate, at least in sections.

In addition, the addition of impregnating agents, at least in sections of the device, in particular, e.g., the addition of one-half percent (0.5%) by volume of solid silicone resin, and subsequent heat treatment can cause the granulate to bond together, which makes the resulting structure more resistant and thus counteracts breakage at the edges of the structure, because granulate grains are bonded to one another and/or to the inner conductor and/or to the tube-shaped metal jacket.

It is particularly advantageous if the coil axis runs parallel to the center axis of the tube of the tube-shaped metal jacket.

This means that the contact surfaces between the electrical heating element and the electrically insulating material, into which granulate or components of the molded part are pressed, run essentially parallel or at right angles to the side of the jacket inner tube.

It is particularly preferred if at least one coil has multiple surfaces in which granulate or components of the molded part are at least partially pressed into the electrical heating element with local deformation in order to increase the contact surface between the electrical heating element and the electrically insulating material. In this way, heat dissipation can be improved in all directions, including inwards and into the spaces between the coils.

In one advantageous refinement of this embodiment, it is provided that the relative increase in the contact surface between the electrical heating element and the electrically insulating material is different for at least two different surfaces into which granulate or components of the molded part are at least partially pressed into the electrical heating element with local deformation. This can be achieved, in particular, by introducing different electrically insulating materials in a targeted manner.

The increase in surface area can be influenced, for example, by changing the particle size distribution of the granulate.

One way to change the increase in surface area is to use a porous molded body as an additional electrically insulating material.

For example, a rod-shaped molded body made of magnesium oxide can be inserted into the interior of the coil and relatively coarse magnesium oxide granulate can be slowly poured into the remaining annular gap between the outer tube and the electrical heating element. After the compaction step, all surfaces of the coils have been modified to a different degree, in particular, more strongly than on inward-facing surfaces.

In the interest of heat dissipation, it is advantageous if the relative increase in the contact surface between the electrical heating element and the electrically insulating material is greatest for the surface facing the tube-shaped metal jacket, into which granulate or components of the molded part are at least partially pressed into the electrical heating element with local deformation.

The method according to the invention for producing an electrical heating device with an electrical heating element which has coils with a flat ribbon geometry at least in sections, the coils with a flat ribbon geometry having an inside diameter, an outside diameter, and a spacing between adjacent coils and being shaped in such a way that the flat side or surface of the coils with a flat ribbon geometry runs parallel to the coil axis, with the electrical heating element being arranged inside the tube interior of a tube-shaped metal jacket and being electrically insulated from it with an electrically insulating material, has the following steps:
production of the electrical heating element,
arrangement of the electrical heating element in the interior of the tube-shaped metal jacket,
introduction of the electrically insulating material into the interior of the tube-shaped metal jacket, and
compaction of the electrically insulating material.

It is preferred that the electrically insulating material is a granulate of grains of different sizes with edges and protrusions or a molded body which is compacted at least to such an extent in the radial direction that sections, in particular edges and protrusions, of granulate grains or fragments of the molded body produced during compaction are pressed into at least one coil surface of at least one coil with a flat ribbon geometry under local deformation of the electrical heating element.

Magnesium oxide, in particular, is well suited as a base material for the electrically insulating material.

It is particularly preferred that the introduction of the electrically insulating material into voids of the interior of the tube-shaped metal jacket takes place at least partially by allowing the granulate to be slowly poured into the tube-shaped metal jacket from one end while being vibrated. This not only promotes the transport of material within the free internal volume of the tube-shaped metal jacket, but the pre-configuration of the grains of the granulate achieved as a result also proves to be helpful for reducing and/or preventing voids.

A magnesium oxide granulate is preferably used as the electrically insulating material, which is constituted in such a way that the electrically insulating material has a tapped density of less than two and forty-five hundredths grams per cubic centimeter (2.45 g/cm³) before compaction.

In particular, when a surface modification of different degrees is to be achieved by pressing granulate into different surfaces of coils, it is helpful if part of the electrically insulating material is also introduced as a molded body into the interior of the tube-shaped metal jacket. For example, a rod-shaped molded body can be inserted into the coil interior of the coils of the electrical heating element, or a tube-shaped molded body can be inserted into the annular gap between the electrical heating element and the tube-shaped metal jacket.

Differences in the strength of the respective surface modifications can also be realized by using different granulate with different grain size distributions to fill different areas of the interior of the tube-shaped metal jacket.

In order to make the electrically insulating material even more stable and, in particular, to prevent it from fracturing in edge areas, it is advantageous if magnesium oxide granulate mixed with an impregnating agent, in particular a silicone resin, are introduced into the interior of the tube-shaped metal jacket as electrically insulating material, at least in sections, and then a heat treatment step is carried out, but not necessarily immediately afterwards, so that granulate grains or components or fragments of the molded body formed by compaction are bonded to one another and/or to the inner conductor and/or to the tube-shaped metal jacket.

It is particularly preferred if such a high pressure is applied during the radial compaction that plastic deformation of the electrical heating element occurs, in particular, a reduction in the cross section of the electrical heating element by a few percent, i.e., in particular between two and ten percent (2%-10%). However, the preferred pressure is dependent on the material and geometry of the particular electrical heating element and tube-shaped metal jacket, which can vary.

Compacting can be realized in particular by press compaction, roller compaction, or hammer compaction.

A magnesium oxide granulate with a grain size distribution whose maximum is in the range between thirty and three hundred micrometers (30 μm-300 μm) is preferred. It is particularly preferred if the range of the grain size distribution is between about thirty and more than one hundred micrometers (30 μm and >100 μm).

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1a is a side elevational, partial cross-sectional view of a first example embodiment of an electrical heating device in a partially open view,

FIG. 1b is a side perspective, cross-sectional view of the electrical heating element of the electrical heating device of FIG. 1a,

FIG. 1c is an enlarged, side perspective and partial cross sectional view of the electrical heating element from FIG. 1b and associated connector pins arranged on the electrical heating element,

FIG. 1d is a cross-sectional view of an area inside the electrical heating device from FIG. 1a, showing portions of the electrical heating element, the tube-shaped metal jacket and an electrically insulating material,

FIG. 1e is a cross-sectional schematic diagram of the structure of magnesium oxide grains and sections of the coil of the electrical heating element and the tube-shaped metal jacket of the electrical heating device from FIG. 1a,

FIG. 2a is a side elevational, partial cross-sectional view of a second example embodiment of an electrical heating device in a partially open view,

FIG. 2b is a side perspective view of an electrical heating element of the electrical heating device from FIG. 2a with connector pins arranged on the electrical heating element,

FIG. 2c is an enlarged detailed cross-sectional view of an area inside the electrical heating device from FIG. 1a,

FIG. 3a is a cross-sectional view of a first variant of a coil of an electrical heating element with surface structures caused by the indentation of grains of the electrically insulating material,

FIG. 3b is a cross-sectional view of a second variant of a coil of an electrical heating element with surface structures caused by the indentation of grains of the electrically insulating material,

FIG. 3c is a cross-sectional view of a third variant of a coil of an electrical heating element with surface structures caused by the indentation of grains of the electrically insulating material, and

FIG. 3d is a cross-sectional view of a fourth variant of a coil of an electrical heating element with surface structures caused by the indentation of grains of the electrically insulating material.

### DETAILED DESCRIPTION OF THE INVENTION

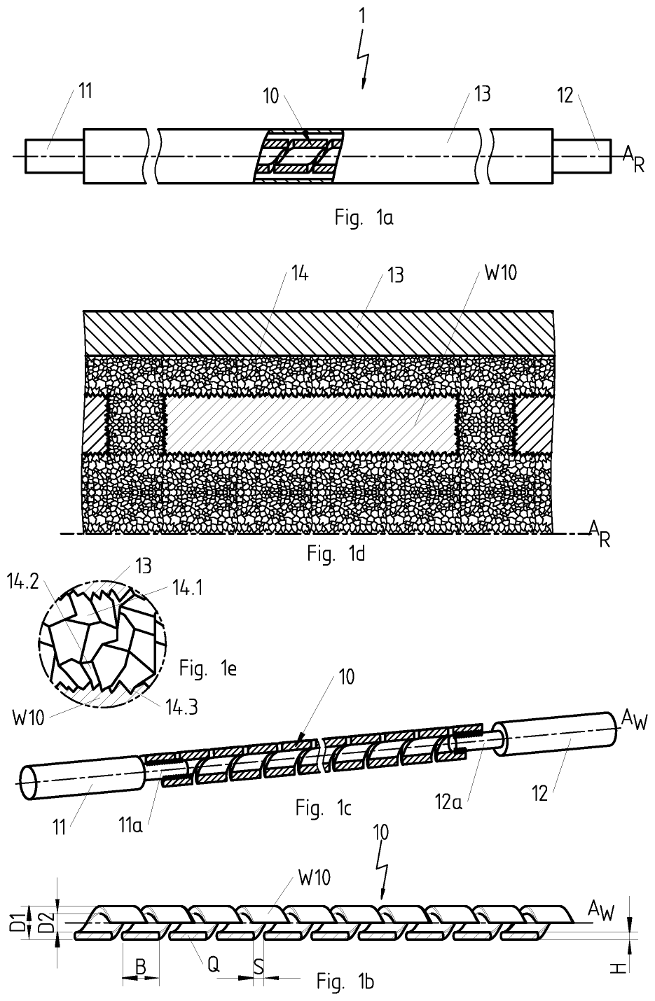

FIGS. 1a to 1e describe a first example embodiment of an electrical heating device 1 in a partially open view, in which, however, the electrically insulating material 14 has been omitted, in particular, in FIG. 1a, in order to improve clarity. The tube-shaped metal jacket 13 can be seen with the center axis AR, in the interior of which the electrical heating element 10 that can be supplied with electricity via connector pins 11, 12 is arranged.

FIG. 1b shows a section through the electrical heating element 10 from FIG. 1a, which is formed here by a coiled resistance wire with a flat ribbon geometry. The figure also shows a number of parameters with which the flat ribbon geometry and the coiled arrangement can be characterized. The generally rectangular cross-sectional areas Q with a long direction of extension defining the width B, and a short direction of extension defining the height H, can be seen. The individual coils W10, which each run around the coil axis AW shown in dashed lines, each have an outside diameter D1 and an inside diameter D2, and adjacent coils W10 are each spaced apart by a spacing S from one another.

In particular, in the illustrated coiled resistance wire 10 with a flat ribbon geometry, it can be seen that:
the width B of the resistance wire with flat ribbon geometry roughly corresponds to the coil outer diameter D1,
the width B of the resistance wire with flat ribbon geometry is about five times as large as its height H, and
the spacing S between adjacent coils W10 is smaller than the width B of the resistance wire with flat ribbon geometry, more precisely about 25 percent of the width B.

Furthermore, when viewed together with FIG. 1a, it becomes clear that the coil axis AW of the electrical heating element 10 and the center axis AM of the tube-shaped metal jacket 13 coincide, so that these two components are arranged concentrically to one another.

FIG. 1c shows the electrical heating element 10 from FIG. 1b in a different sectional view with connector pins 11, 12 arranged thereon. It can be seen that these engage with the corresponding connector sections 11a, 12a in the interior of coils of the electrical heating element 10 and connections can be formed there, for example, by press-contacting.

The detail enlargement of an area inside the electrical heating device from FIG. 1a according to FIG. 1d and a simple diagram according to FIG. 1e of the structure of granulate 14.1,14.2, here magnesium oxide granulate, and sections of the coil W10 of the electrical heating element and the tube-shaped metal jacket 13 of the electrical heating device from FIG. 1a illustrate the important aspect of the invention that the electrically insulating material 14 is a granulate of (magnesium oxide) grains 14.1, 14.2 of different sizes with edges and protrusions 14.3, and that at least one surface of at least one coil W10 has sections in which (magnesium oxide) grains are at least partially pressed into the electrical heating element under local deformation, which is illustrated by the irregularly jagged surfaces of the coil W10. As can be seen in FIG. 1e, there is also a corresponding modification of the inside of the tube-shaped metal jacket 13, which in particular also improves the heat transfer there and contributes to increased mechanical stability.

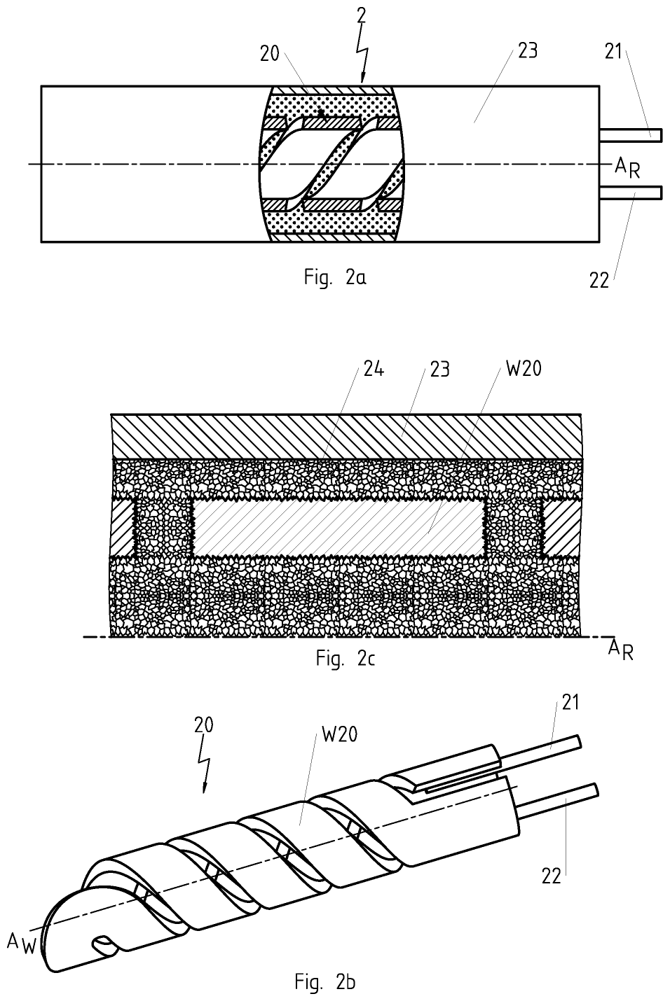

FIGS. 2a to 2c describe a second example embodiment of an electrical heating device 2 in a partially open view, in which, however, the electrically insulating material 24 has been omitted, particularly in FIG. 2a, in order to improve clarity. The tube-shaped metal jacket 23 can be seen with a center axis AR, in the interior of which the electrical heating element 20 that can be supplied with electricity via connector pins 21, 22 is arranged.

FIG. 2b shows an external view of the electrical heating element 20 from FIG. 2a, which is produced here by winding a slotted plate made from a resistance wire material, imparting a flat ribbon geometry on the resulting coils W20. Furthermore, when viewed together with FIG. 2a, it can be seen that the coil axis AW of the electrical heating element 20 and the center axis AM of the tube-shaped metal jacket 23 coincide, so that these two components are arranged concentrically to one another.

The detail enlargement of an area inside the electrical heating device from FIG. 2a according to FIG. 2d illustrates essentially in the same way as FIGS. 1d and 1e that the electrically insulating material 24 is a granulate of (magnesium oxide) grains of different sizes with edges and protrusions, and that at least one surface of at least one coil W10 has sections in which (magnesium oxide) grains are at least partially pressed into the electrical heating element with local deformation, which is illustrated by the irregularly jagged surfaces of the coil W10.

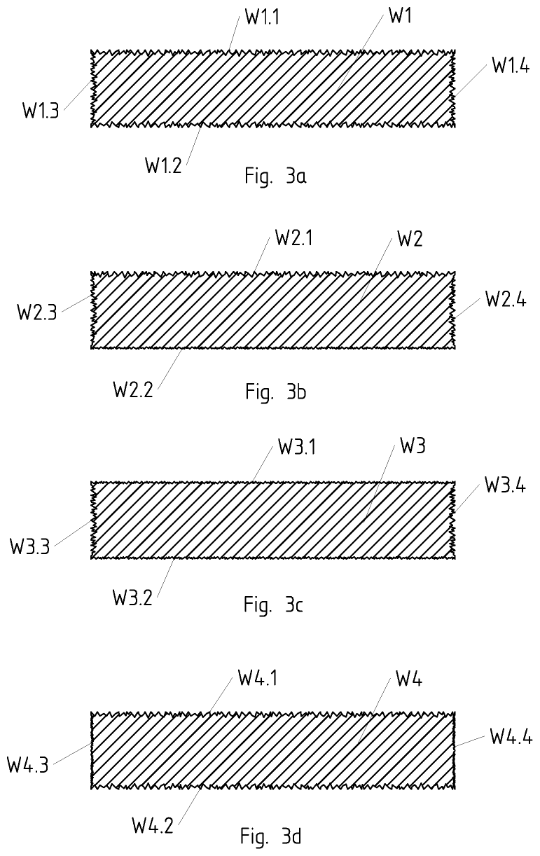

FIGS. 3a to 3d show four different variants of coils W1, W2, W3, W4 in cross section, which clearly shows the flat ribbon-shaped cross section. The coils W1, W2, W3, W4 each have four sides or surfaces W1.1, W1.2, W1.3, W1.4; W2.1, W2.2, W2.3, W2.4; W3.1, W3.2, W3.3, W3.4; W4.1, W4.2, W4.3, W4.4, which differ in terms of their surface roughness caused by the indentation of particles of the electrically insulating material, in particular magnesium oxide granulate, and thus have different effective boundary surfaces to the electrically insulating material available for heat transfer. The sides or surfaces W1.1, W2.1, W3.1, and W4.1 face the inside of the tube-shaped metal jacket, the sides or surfaces W1.2, W2.2, W3.2, and W4.2 face its center axis AR, and the remaining sides or surfaces W1.3, W2.3, W3.3, W4.1, W4.1, W4.2, W4.3, W4.4 face the respective adjacent coils.

In the illustration according to FIG. 3a, the resulting surface roughness of the coil W1 is approximately the same on all four sides or surfaces W1.1, W1.2, W1.3, W1.4. This result can be achieved with a homogeneous filling with (magnesium oxide) granulate; the degree of roughness can be influenced by the selection of the grain size distribution.

On the other hand, in the illustration according to FIG. 3b, the resulting surface roughness of the coil W2 on the side or surface W2.2 facing the center axis AR of the tube-shaped metal jacket is less than on the other sides or surfaces W2.1, W2.3, W2.4.

In particular, by filling in layers of (magnesium oxide) granulate with different grain size distributions, it is possible to compare the roughness of sides or surfaces W3.1, W3.2, W4.1, W4.2, which are oriented in or against the radial direction to sides or surfaces W3.3, W3.4, W4.3, W4.4 oriented in or against the direction of extension of the electrical heater, as can be seen in FIGS. 3c and 3d.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

1, 2 Electrical heating device
10, 20 Electrical heating element
11, 12, 21, 22 Connector pin
11a, 12a Connector section
13, 23 Tube-shaped metal jacket
14, 24 Electrically insulating material
14.1, 14.2 Granulate grains
14.3 Protrusion
AR Center axis
AW Coil axis
B Width
D1 Outer diameter
D2 Inner diameter
H Height
Q Cross-sectional surface area
S Spacing
W1, W2, W3, W4, W10, W20 Coil
W1.1, W1.2, W1.3, W1.4,
W2.1, W2.2, W2.3, W2.4,
W3.1, W3.2, W3.3, W3.4,
W4.1, W4.2, W4.3, W4.4, Surface

1. An electrical heating device with an electrical heating element, which is arranged, without a carrier, inside the tube interior of a tube-shaped metal jacket and is electrically insulated from the metal jacket with a compacted, electrically insulating material, the electrical heating element comprising:
coils with a flat ribbon geometry, wherein the coils have an inner diameter, an outer diameter, and a spacing between adjacent coil and are shaped such that a flat side of the coils runs parallel to a coil axis, at least in portions of an interior of the tube-shaped metal jacket that borders at least one of the coils, the compacted electrically insulating material is a compacted granulate made from granulate grains of different sizes with edges and protrusions or a compacted molded part made from an electrically insulating material, at least one surface of at least one coil of the coils has sections, in which either granulate grains or components of the molded part produced during the compaction of the molded part are pressed at least partially into the electrical heating element under local deformation of the electrical heating element.

2. The electrical heating device according to claim 1, wherein the compacted granulate is impregnated at least in sections.

3. The electrical heating device according to claim 2, wherein the granulate grains are bonded with each other by an impregnating medium and subsequent heat treatment.

4. The electrical heating device according to claim 1, wherein the coil axis runs parallel to a tube center axis of the tube-shaped metal jacket.

5. The electrical heating device according to claim 1, wherein at least one coil of the coils has multiple surfaces in which the granulate grains or components of the molded part produced during the compaction of the molded part, under local deformation of the electrical heating element, are pressed at least partially into the electrical heating element.

6. The electrical heating device according to claim 5, wherein a relative increase in a surface contact between the electrical heating element and the electrically insulating material is different for at least two different surfaces in which the granulate grains, under local deformation of the electrical heating element, are pressed at least partially into the electrical heating element.

7. The electrical heating device according to claim 6, wherein a relative increase in a surface contact between the electrical heating element and the electrically insulating material is greatest for a surface facing the tube-shaped metal jacket, in which the granulate grains or components of the molded part produced during the compaction of the molded part, under local deformation of the electrical heating element, are pressed at least partially into the electrical heating element.

8. A method for producing an electrical heating device with an electrical heating element, which has, at least in some sections, coils with a flat ribbon geometry, wherein the coils have an inner diameter, an outer diameter, and a spacing between adjacent coils and are shaped such that a flat side of the coils runs parallel to a coil axis, the electrical heating element is arranged inside a tube interior of a tube-shaped metal jacket and is electrically insulated from the metal jacket with an electrically insulating material, the method comprising:
producing the electrical heating element,
arranging the electrical heating element in the tube interior of the tube-shaped metal jacket,
introducing the electrically insulating material into the tube interior of the tube-shaped metal jacket, and
compacting the electrically insulating material, wherein the electrically insulating material is a granulate made from granulate grains of different sizes with edges and protrusions or a molded part, wherein the granulate grains or the molded part is compacted in a radial direction such that sections of granulate grains, especially edges and protrusions, or components of the molded part produced during the compaction of the molded part, under local deformation of the electrical heating element, are pressed into at least one surface of at least one coil of the coils.

9. The method according to claim 8, wherein the introduction of the electrically insulating material into the tube interior of the tube-shaped metal jacket is realized at least partially such that the granulate grains of the granulate can be slowly added into the tube-shaped metal jacket from one end under a vibrating motion.

10. The method according to claim 8, wherein the electrically insulating material has a tapped density of less than 2.45 g/cm³ before the compacting step.

11. The method according to claim 9, wherein a part of the electrically insulating material is introduced as a molded body into the tube interior of the tube-shaped metal jacket.

12. The method according to claim 8, wherein an impregnating medium, in particular, a silicone resin, is introduced as an electrically insulating material into the tube interior of the tube-shaped metal jacket and a heat-treatment step is performed, such that the granulate grains are bonded with each other.

13. The method according to claim 8, wherein a high pressure is used during the compacting step and produces a plastic deformation of the electrical heating element.

14. The method according to claim 8, wherein the granulate is comprised of a magnesium oxide granulate, the magnesium oxide granulate has a grain size distribution, a maximum grain size distribution is in the range between 30 μm and 300 μm.

15. The method according to claim 14, wherein a full width half maximum of the grain size distribution of the magnesium oxide granulate is greater than approximately 30 μm.

16. The electrical heating device according to claim 2, wherein the granulate grains are bonded with the electrical heating element by an impregnating medium and subsequent heat treatment.

17. The electrical heating device according to claim 2, wherein the granulate grains are bonded with tube-shaped metal jacket by an impregnating medium and subsequent heat treatment.

18. The method of claim 8, wherein an impregnating medium is introduced into the tube interior of the tube-shaped metal jacket and a heat-treatment step is performed such that the granulate grains are bonded with the tube-shaped metal jacket.

19. The method of claim 13, wherein the elastic deformation reduces a cross-section of the electrical heating element.

20. The method of claim 14, wherein a full width half maximum of the train size distribution of the magnesium oxide granulate is in a range of 30 μm to 100 μm.
